(19) United States
(12) Patent Application Publication
(10) Pub. No.: US 2018/0291840 A1
(43) Pub. Date: Oct. 11, 2018

(54) DEVICE FOR ALTERING INFRARED SIGNATURE OF AN EXHAUST DUCT AND METHOD OF ALTERING AN INFRARED SIGNATURE OF AN EXHAUST DUCT

(71) Applicant: Sikorsky Aircraft Corporation, Stratford, CT (US)

(72) Inventors: Joseph Pantalone, III, Guilford, CT (US); Jeremy Remi Beaudry, Monroe, CT (US)

(21) Appl. No.: 15/767,049

(22) PCT Filed: Oct. 10, 2016
(86) PCT No.: PCT/US16/56280

§ 371 Date: Apr. 9, 2018

Related U.S. Application Data
(60) Provisional application No. 62/240,813, filed on Oct. 13, 2015.

(51) Int. Cl. F02K 1/82; B64D 33/04

(52) U.S. Cl. CPC F02K 1/825; B64D 2033/045; B64D 33/04

(57) ABSTRACT

A device for altering infrared signature of an exhaust duct includes a housing configured to attach to an exhaust duct of a vehicle and at least one body attached to the housing at opposing ends of the at least one body, an opening in at least one of the opposing ends being in fluidic communication with a cavity within the at least one body such that fluid can flow into the cavity through the opening.

### BACKGROUND

Exhaust ducts on vehicles can create infrared signatures that may be detectable by imaging equipment configured to image objects in the infrared wavelengths. Such signatures can be used to target the vehicles. Devices and methods to alter the infrared signatures of a vehicle are of interest to those concerned with such matters. cl BRIEF DESCRIPTION

Disclosed herein is a device for altering infrared signature of an exhaust duct. The device includes a housing configured to attach to an exhaust duct of a vehicle and at least one body attached to the housing at opposing ends of the at least one body, an opening in at least one of the opposing ends being in fluidic communication with a cavity within the at least one body such that fluid can flow into the cavity through the opening.

In addition to one or more of the features described above, or as an alternative, further embodiments include the at least one opening being in fluidic communication with a space defined between the exhaust duct and a fairing.

In addition to one or more of the features described above, or as an alternative, further embodiments include that at least one of the opposing ends is sealed to the housing.

In addition to one or more of the features described above, or as an alternative, further embodiments include that the at least one body includes at least one hole between the opposing ends through which fluid can flow.

In addition to one or more of the features described above, or as an alternative, further embodiments include the at least one body being shaped such that flow past the at least one body in an orientation substantially perpendicular to a portion of the at least one body between the opposing ends causes entrainment of fluid through the opening and out through the at least one hole.

In addition to one or more of the features described above, or as an alternative, further embodiments include the at least one hole being positioned on the at least one body so that fluid entrained out of the at least one hole flows along a surface of the at least one body.

In addition to one or more of the features described above, or as an alternative, further embodiments include the surface having features to deter heat transfer therefrom.

In addition to one or more of the features described above, or as an alternative, further embodiments include the housing being configured to be removably attached to the exhaust duct.

In addition to one or more of the features described above, or as an alternative, further embodiments include the at least one body being attached to the exhaust duct at angles different than angles of components within the exhaust duct.

In addition to one or more of the features described above, or as an alternative, further embodiments include the at least one body being configured to block a line-of-sight of hot components inside the exhaust duct from an outside of the exhaust duct.

Further disclosed herein is a method of altering an infrared signature of an exhaust duct. The method includes positioning at least one body across an outlet of the exhaust duct, flowing fluid through at least a portion of the at least one body, and cooling the at least one body with the flowing fluid.

In addition to one or more of the features described above, or as an alternative, further embodiments include flowing fluid out of the at least one body through at least one hole in the at least one body.

In addition to one or more of the features described above, or as an alternative, further embodiments include entraining fluid to flow through the at least one hole.

In addition to one or more of the features described above, or as an alternative, further embodiments include angling the at least one body nonparallel to components within the exhaust duct.

Further disclosed herein is an aircraft that includes a fuselage, an engine in operable communication with the fuselage, an exhaust duct in operable communication with the engine, and any of the foregoing devices for altering infrared signature of an exhaust duct.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 depicts an exploded view of an exhaust infrared signature altering device disclosed herein;

FIG. 2 depicts a perspective view of the exhaust infrared signature altering device of FIG. 1;

FIG. 3 depicts another perspective view of the exhaust infrared signature altering device of FIG. 1;

FIG. 4 depicts a perspective view of a body of the exhaust infrared signature altering device of FIG. 1;

FIG. 5 depicts a perspective view of an exhaust duct with the exhaust infrared signature altering device of FIG. 1 attached thereto;

FIG. 6 depicts a schematic view of an exhaust duct with the exhaust infrared signature altering device of FIG. 1 attached thereto;

FIG. 7 depicts a schematic view of an exhaust duct with the exhaust infrared signature altering device of FIG. 1 attached thereto in an alternate configuration;

FIG. 8 depicts a perspective view of an exhaust duct;

FIG. 9 depicts a perspective view of the exhaust duct of FIG. 8 with the exhaust infrared signature altering device of FIG. 1 attached thereto; and

FIG. 10 depicts a side view of a vehicle employing the exhaust infrared signature altering device of FIG. 1.

### DETAILED DESCRIPTION

A detailed description of one or more embodiments of the disclosed apparatus and method are presented herein by way of exemplification and not limitation with reference to the Figures.

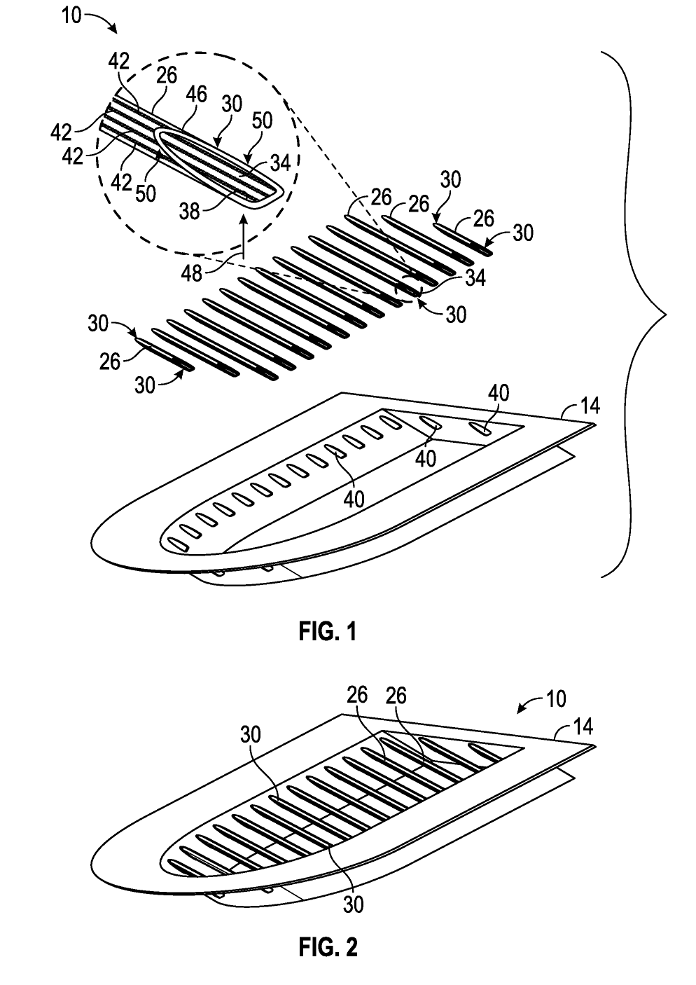

Referring to FIGS. 1-3, a device for altering an infrared signature of an exhaust system is illustrated at 10. The device 10 includes, a housing 14 configured to attach to an exhaust duct 18 (FIG. 6) of a vehicle 22 (FIG. 10), such as an aircraft, for example. The device 10 also includes at least one body 26, with a plurality of the bodies 26 being shown in the FIGS. that are attached to the housing 14 at opposing ends 30 of the bodies 26. An opening 34 in at least one of the opposing ends 30 is in fluidic communication with a cavity 38 within the bodies 26 such that fluid can flow into the cavity 38 through the opening 34. In embodiments disclosed herein the bodies 26 include one of the openings 34 at both of the opposing ends 30. Additionally, the opposing ends 30 of the bodies 26 are sealed to the housing 14 at ports 40 that allow fluid to flow therethrough and into the cavity 38.

The bodies 26 in the illustrated embodiment also include at least one hole 42, with a plurality being shown, through walls 46 that define the cavities 38. The holes 42 are positioned between the opposing ends 30. As such, fluid is able to flow through the openings 34, the cavities 38 and the holes 42. Furthermore, the bodies 26 have a cross sectional shape such that flow past the bodies 26 in an orientation substantially perpendicular to a longitudinal extent of the bodies 26, in the direction of arrow 48, between the opposing ends 30 causes fluid to be entrained through the openings 34 and out through the holes 42. The cross sectional shape of the bodies 26 may resemble an airfoil to create low pressure regions on opposing surfaces 50 of the bodies 26 in response to fluid flowing therepast.

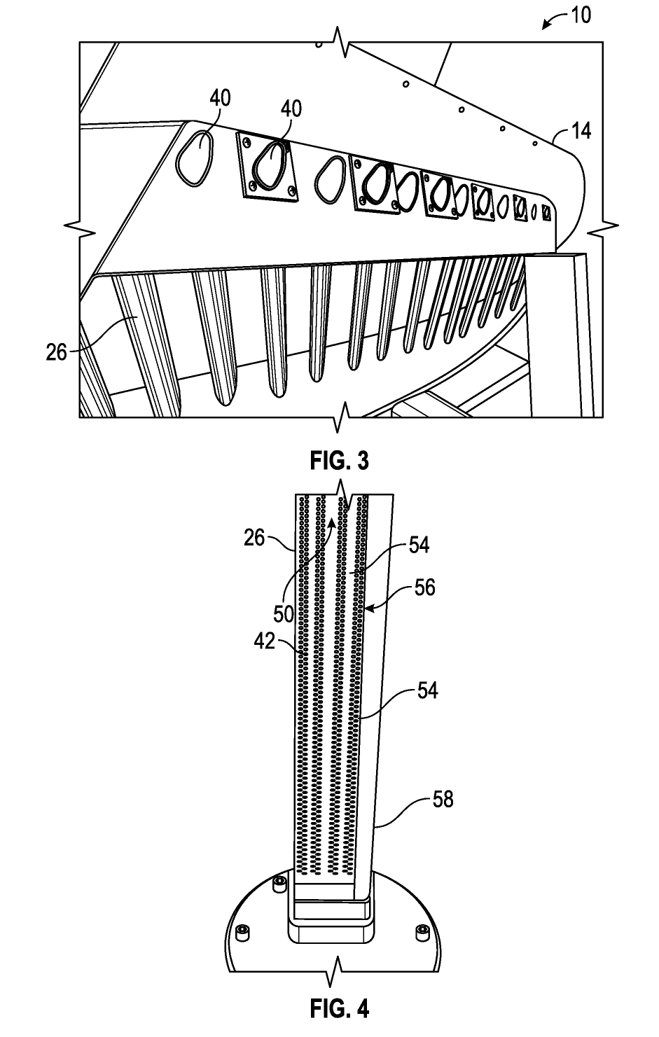

Referring to FIG. 4, the holes 42 can be positioned such that fluid that flows out from the cavities 38 and through the holes 42 can flow along the surfaces 50 of the bodies 26 thereby providing film cooling to the surface 50 and the bodies 26. Additionally, the surface 50 in some embodiments has features 54 configured to deter heat transfer from the bodies 26. These features 54 may include modifications to the surface 50, such as by etching or plasma coating, for example, or could be via addition of an alternate material 58 such as by applying tape or a coating of the alternate material 58. These features 54 can be applied uniformly over the entirety of the surface 50 or selectively placed, such as on the leading edge 56 only, for example, depending upon specifics of each application.

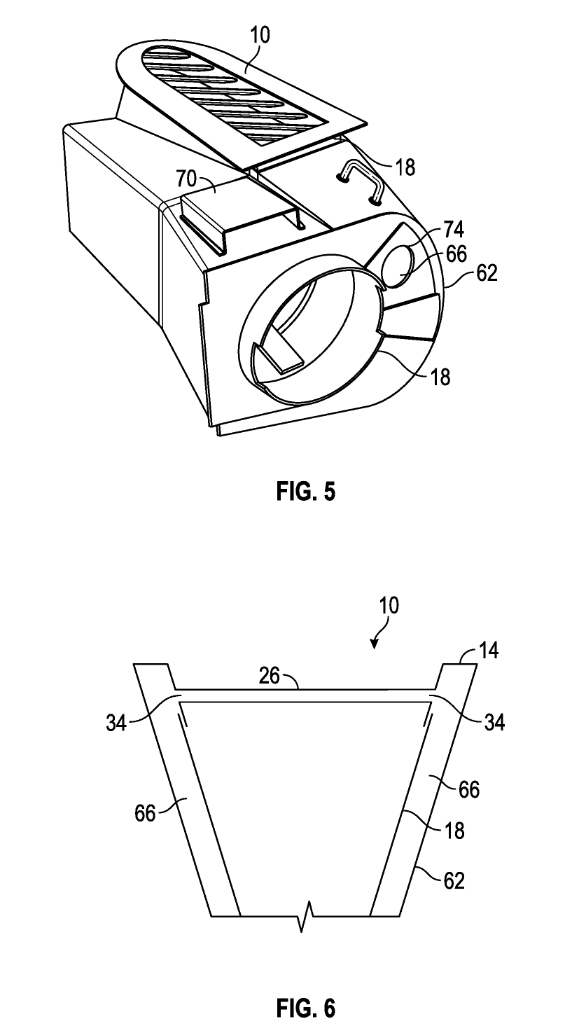

Referring to FIG. 5, the device 10 can be integrated into the exhaust duct 18 or can be made to be removably attachable to the exhaust duct 18. Being removably attachable allows the device 10 to be attached for specific missions while being left off of the exhaust duct 18 for other missions. A fairing 62 may be in operable communication with the exhaust duct 18 in such a way as to define a space 66 between the exhaust duct 18 and the fairing 62. Fluid such as air may be allowed to flow through this space 66 and cool the exhaust duct 18 in the process. The fluid may be RAM air or IPS (Inlet Particle Separator) air. A RAM inlet 70 allows the RAM air to enter the space 66 via forces generated due to the vehicle 22 movement. Similarly, an IPS inlet 74 allows IPS air to enter the space 66.

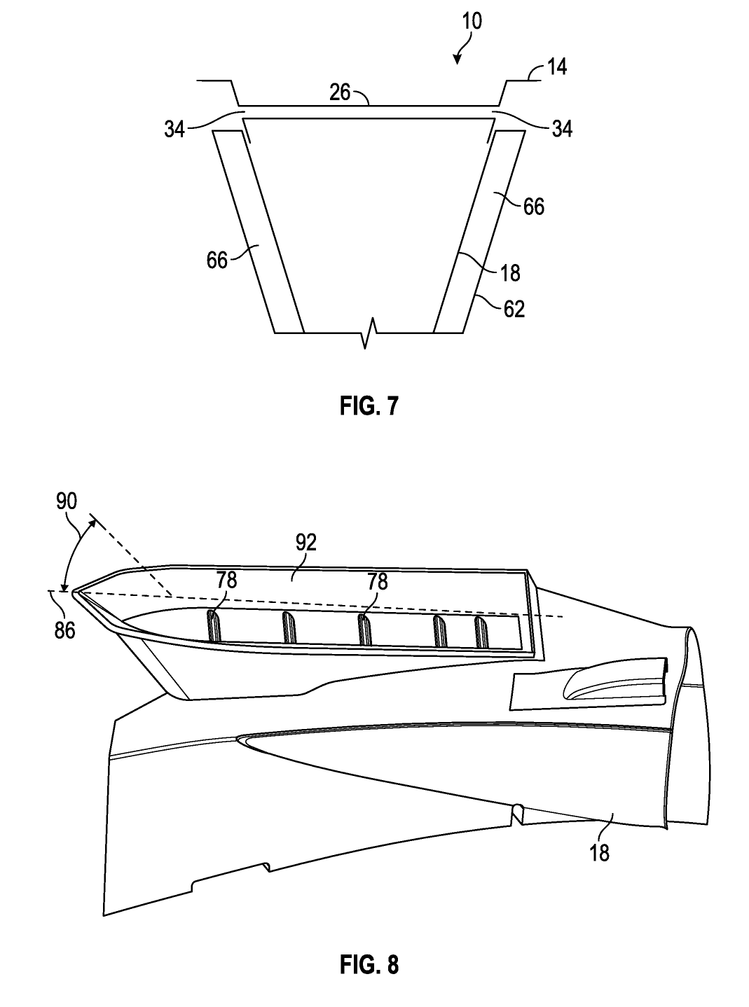

Referring to FIGS. 6 and 7, the device 10 can be attached to the exhaust duct 18 in a few different ways. In FIG. 6 the housing 14 of the device 10 is sealed to the exhaust duct 18 and to the fairing 62 such that the openings 34 are in fluidic communication with the space 66. In this configuration fluid flowing through the bodies 26 is RAM air or IPS air. In FIG. 7 the housing is sealed to the exhaust duct 18 in such a way that the openings 34 are not in direct fluidic communication with the space 66. In this configuration fluid that flows into the openings 34 and through the bodies 26 is not RAM air or IPS air but instead is ambient air from outside the space 66. In either configuration fluid that flows through the bodies 26 will typically be much cooler than temperatures inside the exhaust duct 18.

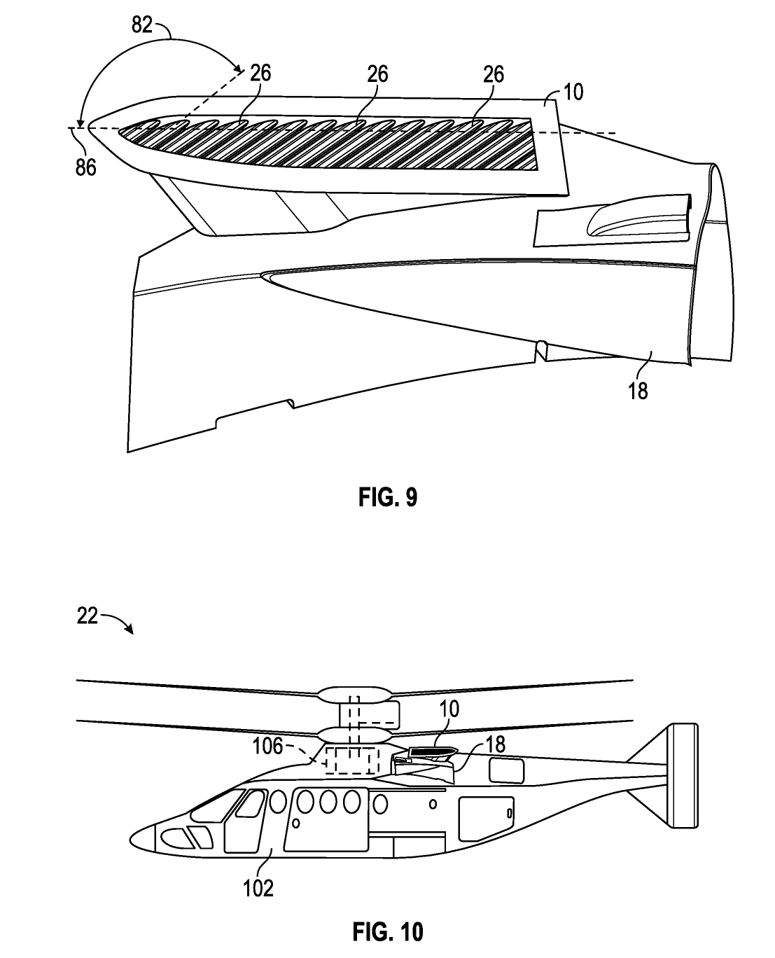

Referring to FIGS. 8 and 9, components 78, such as fins for example (FIG. 8 only), positioned within the exhaust duct 18 can have temperatures that are greater than temperatures outside of the exhaust duct 18. These components 78 can create an infrared signature that can be detected by equipment that has a line-of-sight to these components 78. The bodies 26 being cooled by the methods disclosed herein can block a line-of-sight to these components 78 from such detection equipment. However, since some clearance is required between the adjacent bodies 26, a line-of-sight to such components 78, though reduced in comparison to systems wherein the bodies 26 are not present, may still exist. Embodiments disclosed herein orient the bodies 26 at an angle 82 relative to a longitudinal axis 86 of the exhaust duct 18, for example, that is intentionally different from an angle 90 of the components 78 relative to the axis 86 and thus the components 78 are not parallel to the bodies 14. The foregoing can decrease an infrared signature due along a line-of-sight between the adjacent bodies 26 in comparison to a configuration wherein the angles 82 and 90 are equal.

The foregoing structures allow one to alter an infrared signature of an exhaust duct 18. In one embodiment the alteration includes positioning at least one body across an outlet 92 of the exhaust duct 18, flowing fluid through at least a portion (the cavity 38) of the at least one body 26, and cooling the at least one body 26 with the flowing fluid. Furthermore, one could flow fluid out of the at least one body 26 through at least one hole 42 in the at least one body 26, as well as entraining fluid to flow through the at least one hole 42. In another embodiment the bodies 26 can be oriented nonparallel to components 78 within the exhaust duct 18.

Referring to FIG. 10, the vehicle 22 is illustrated as a rotary wing aircraft 22 having among other things a fuselage 102, an engine 106, the exhaust duct 18 in operable communication with the engine 106, and the exhaust infrared signature altering device 10. The device 10 can be disposed on the aircraft 22 to alter an infrared signature of the aircraft 22 in manners disclosed herein.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A device for altering infrared signature of an exhaust duct, comprising:
a housing configured to attach to an exhaust duct of a vehicle; and
at least one body attached to the housing at opposing ends of the at least one body, an opening in at least one of the opposing ends being in fluidic communication with a cavity within the at least one body such that fluid can flow into the cavity through the opening.

2. The device for altering infrared signature of an exhaust duct of claim 1, wherein the at least one opening is in fluidic communication with a space defined between the exhaust duct and a fairing.

3. The device for altering infrared signature of an exhaust duct of claim 1, wherein the at least one of the opposing ends is sealed to the housing.

4. The device for altering infrared signature of an exhaust duct of claim 1, wherein the at least one body includes at least one hole between the opposing ends through which fluid can flow.

5. The device for altering infrared signature of an exhaust duct of claim 4, wherein the at least one body is shaped such that flow past the at least one body in an orientation substantially perpendicular to a portion of the at least one body between the opposing ends causes entrainment of fluid through the opening and out through the at least one hole.

6. The device for altering infrared signature of an exhaust duct of claim 5, wherein the at least one hole is positioned on the at least one body so that fluid entrained out of the at least one hole flows along an surface of the at least one body.

7. The device for altering infrared signature of an exhaust duct of claim 6, wherein the surface has features to deter heat transfer therefrom.

8. The device for altering infrared signature of an exhaust duct of claim 1, wherein the housing is configured to be removably attached to the exhaust duct.

9. The device for altering infrared signature of an exhaust duct of claim 1, wherein the at least one body is attached to the exhaust duct at angles different than angles of components within the exhaust duct.

10. The device for altering infrared signature of an exhaust duct of claim 1, wherein the at least one body is configured to block a line-of-sight of hot components inside the exhaust duct from an outside of the exhaust duct.

11. A method of altering an infrared signature of an exhaust duct, comprising:
positioning at least one body across an outlet of the exhaust duct;
flowing fluid through at least a portion of the at least one body; and
cooling the at least one body with the flowing fluid.

12. The method of claim 11, further comprising flowing fluid out of the at least one body through at least one hole in the at least one body.

13. The method of claim 11, further comprising entraining fluid to flow through the at least one hole.

14. The method of claim 11, further comprising angling the at least one body nonparallel to components within the exhaust duct.

15. An aircraft, comprising:
a fuselage;
an engine in operable communication with the fuselage;
an exhaust duct in operable communication with the engine; and
a device for altering infrared signature of an exhaust duct of claim 1.
